(19) United States
(12) Patent Application Publication
(10) Pub. No.: US 2015/0159636 A1
(43) Pub. Date: Jun. 11, 2015

(54) SPRING BASED ELECTRICAL POWER GENERATOR

(71) Applicant: A. Arul Francis, Cuddalore (IN)

(72) Inventor: A. ARUL FRANCIS, CUDDALORE (IN)

(21) Appl. No.: 14/333,522

(22) Filed: Jul. 17, 2014

(30) Foreign Application Priority Data
Dec. 10, 2013 (IN) 5680/CHE/2013

(51) Int. Cl. F03G 1/06; H02K 7/18

(52) U.S. Cl. CPC F03G 1/06; H02K 7/18; Y10S 74/09; H02K 53/00

(57) ABSTRACT

The present invention discloses a spring based generator for conversion of the vibrational energy into significantly storable electrical energy. The present invention's generator is portable and does not need any fluid like petrol, diesel, water etc. for its starting or running. The manufacturing and maintenance cost of the generator is highly less due to least complex assembly. The present invention creates minimum noise and provides continuous power generation.

### BACKGROUND

1. Technical Field of Invention

The present invention generally relates to a portable electrical power generator and particularly relates to a spring based power generator. The present invention more particularly relates to a generation and a storage of high amount energy through a compression and expansion mechanism of the spring.

2. Description of Related Art

The elastic or spring energy is the potential mechanical energy stored in configuration of a material or physical system as work is performed to distort its volume or shape. The elasticity theory primarily develops an analytical understanding of the mechanics of solid bodies and materials. The elastic potential energy equation is used in calculations of positions of mechanical equilibrium. The energy is potential as it will be converted into another form of energy, such as kinetic. A continuous vibration motion of an elastic object like spring results in conversion of energy i.e. potential energy to kinetic energy. During this process there is a certain amount of energy is released as a part of work done which is potentially harnessed as a power source.

One of the prior arts discloses a spring type generator. A rotating shaft of a body building vehicle is connected with a spring shaft of a spring. The spring shaft of the spring is connected with a ratchet wheel and the ratchet wheel is provided with a ratchet pawl. The spring shaft of the spring is connected with an input shaft of a transmission, and an output shaft of the transmission is connected with a rotor shaft of the generator. After the spring is tightened, the ratchet pawl can be wrenched so as to open the ratchet wheel, the ratchet wheel can be released with the elastic potential energy so as to drive a generator shaft to rotate and generate an electric energy.

Another prior art discloses an emergency power system for operation during loss of power on power mains comprises a spring-driven energy storage unit (ESU) and a generator. The ESU enters a generator mode responsive to a power outage state of a power sensor, during which mode unwinding of the spring drive powers the generator. After power is restored to the main supply, a preferred embodiment automatically rewinds the spring using the generator as a motor.

However the energy generated through the spring based system in the prior arts is of very low amount and the device has to run for a long period of time to generate significant amount of power. The prior arts also implements single sided clamping for the compression of the spring but this result in impulsive reversal of spring from a contraction movement to an expansion movement that breaks the continuity in generation of electrical energy and gradually damages the spring body and its performance. The prior arts also fail to implement an automated source that ensures the running of the spring based generator systems for a long period.

In the view of foregoing, there is a need for a spring based generator with very long time running mechanism. Further there is need for a portable spring based generator to produce significantly large amount of electrical energy at continuous basis. Also there is a need for a spring based generator with easily assembly-able components.

The above mentioned shortcomings, disadvantages and problems are addressed herein, as detailed below.

### OBJECT OF THE INVENTION

The primary object herein is to provide a spring based generator with highly prolonged running mechanism.

Another object herein is to provide a portable spring based generator to produce significantly large amount of electrical energy on continuous basis.

Yet another object herein is to provide a spring based generator with easily assemble-able components.

Yet another object herein is to provide a spring based generator with a high energy conversion and storage rate.

These and other objects and advantages of the embodiments herein will become readily apparent from the following detailed description taken in conjunction with the accompanying drawings.

### SUMMARY OF THE INVENTION

The various embodiments herein disclose spring based generator for conversion of the vibrational energy of spring into an electrical energy. The generator comprises a self-starter, a flywheel, an electrical motor, a plurality of spring assembly, an input spring assembly, a highly compressed spring coil, an output spring assembly, an oil sump, an oil pipe, an oil drain, a primary transmission gear, a secondary transmission gear, a bearing, an alternator, a coupling, a power supply, a control panel and a base frame. The self starter enables a user to the start the generator. The flywheel is connected to the self-starter. The flywheel starts rotating and transfers the power to the alternator. The electrical motor is connected to the flywheel through a feedback medium. The feedback transfers an amount of power back to the electrical motor connected with spring assembly. Each phase of the spring assembly comprises an input spring drum with gear assembly, a highly compressed spring coil and an output spring drum with gear assembly. The input spring assembly is connected to the electric motor through a secondary gear. The highly compressed spring coil stores potential energy that is converted into kinetic energy. The plurality of spring assembly is cranked by the input spring assembly on one side. The output spring assembly cranks the plurality of spring assembly from another side. The input and output spring drums rotate on the opposite direction. The oil sump stores lubricating oil for input and output spring assembly. The oil pipe acts as an inlet to fresh oil into the oil sump. The oil drain acts as an output for used oil from the oil sump. The primary transmission gear transmits the rotational power from one spring assembly to another. The secondary transmission gear transfers energy to the bearing. The bearing is coupled to the secondary transmission gear. An output is taken from the alternator. A feedback is taken from the alternator to the electric motor. The coupling maintains continuity of power flow from the flywheel to the alternator. The power supply acts as the feedback to the electric motor. The control panel manages the speed and power flow for the generator. The base frame houses the generator.

According to an embodiment herein, the output power taken from the alternator is in the range of 90-95%.

According to an embodiment herein, the feedback power is taken from the alternator to the electrical motor is in the range 5-10%. The feedback power maintains the continuous flow of power for continuous cranking or movement of spring. Thus, the generator herein avoids need of an outer power source for its continuous running.

According to an embodiment herein, the pluralities of spring assemblies are separated in a shell dram. The shell drum acts as a base frame. A centre shaft is fixed in the shell drum with two bearings of inner race. The output surface of the bearing is fixed with an input spring drum cone portion. The output spring drum is fixed on the centre shaft with two bearings. The two bearings maintain a safety gap between the input and output spring drums. Both the spring drums are connected with the ends of the spring coil by a clamp.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a spring based generator, according to one embodiment herein.

FIG. 2 illustrates a spring assembly in the generator, according to one embodiment herein.

FIG. 3 illustrates a de-assembled view of the spring drum assembly, according to one embodiment herein.

FIG. 4 illustrates an enlarged view of a spring drum assembly, according to one embodiment of the present herein.

FIG. 5 illustrates an enlarged view of a spring loader cone, according to one embodiment of the present herein.

FIG. 6 illustrates a perspective view of spring assembly along with output shell drum, according to one embodiment herein.

FIG. 7 illustrates a bearing housing in the generator, according to one embodiment herein.

FIG. 8 illustrates a side view of the transmission gear, according to one embodiment herein.

FIG. 9 illustrates a side view of the shaft in the spring assembly, according to one embodiment herein.

FIG. 10 illustrates a gear assembly in the generator, according to one embodiment herein.

FIG. 11 illustrates a spring guider in the spring assembly, according to one embodiment herein.

FIG. 12 illustrates a step down and step up gear in the spring assembly, according to one embodiment herein.

FIG. 13 illustrates flywheel assembly with self-starter and break control, according to one embodiment herein.

FIG. 14 illustrates an alternator integrated with the control panel, according to one embodiment herein.

### DETAILED DESCRIPTION OF THE DRAWINGS

In the following detailed description, a reference is made to the accompanying drawings that form a part hereof, and in which the specific embodiments that may be practiced is shown by way of illustration. The embodiments are described in sufficient detail to enable those skilled in the art to practice the embodiments ant is to be understood that the logical, mechanical and other changes may be made without departing from the scope of the embodiments. The following detailed description is therefore not to be taken in a limiting sense.

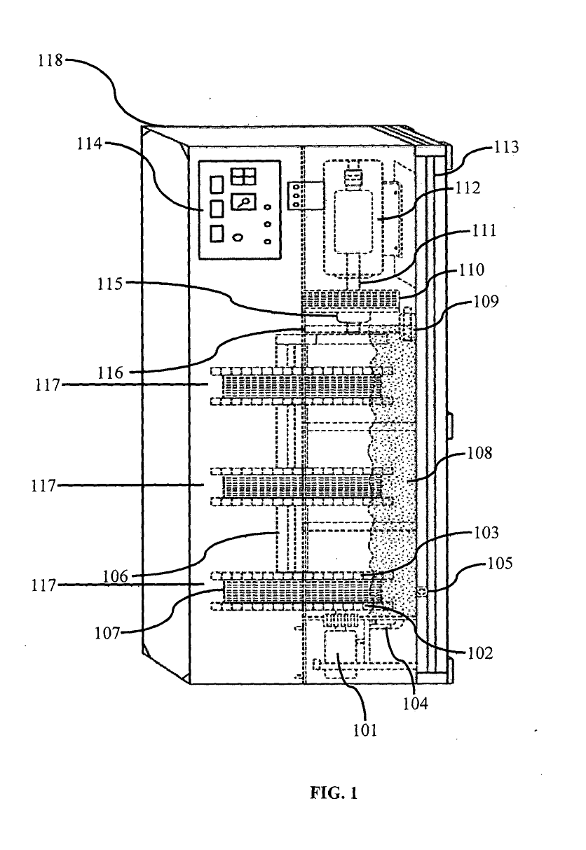

FIG. 1 illustrates a spring based generator, according to one embodiment herein. With respect to FIG. 1. The generator comprises a self-starter 109, a flywheel 110, an electrical motor 101, a plurality of spring assembly 117, an oil sump 108, an oil pipe 104, an oil drain 105, a primary transmission gear 106, a secondary transmission gear 116, a bearing 115, an alternator 112, a coupling 111, a power supply 113, a control panel 114 and a base frame 118. The self starter 109 enables a user to the start the generator. The flywheel 110 is connected to the self-starter 109. The flywheel 110 starts rotating and transfers the power to the alternator 112. The electrical motor 101 is connected to the flywheel 110 through a feedback medium. The feedback transfers an amount of power back to the electrical motor 101 from the output power. Each phase of the spring assembly 117 comprises an input spring drum 102, a highly compressed spring coil 107 and an output spring drum 103. The input spring drum 102 with gear is connected to the electric motor 101 through a secondary gear. The highly compressed spring coil 107 stores a potential energy that is converted into kinetic energy. The plurality of spring assembly 117 is cranked by the input spring drum assembly 102 on one side. The oil sump 108 stores lubricating oil for input and output spring drum assembly (102 and 103). The oil pipe 104 acts as an inlet to fresh oil into the oil sump 108. The oil drain 105 acts as an output for used oil from the oil sump 108. The primary transmission gear 106 transmits the rotational power from one spring assembly 117 to another. The secondary transmission gear 116 transfers the energy to the bearing 115. The bearing 115 is coupled to the secondary transmission gear 116. The alternator 112 converts the power transferred from the bearing 115 to the electrical current. An output is taken from the alternator 112. A feedback is taken from the alternator 112 to the electric motor 101. The coupling 111 maintains continuity of power flow from the bearing 115 to the alternator 112. The power supply 113 acts as the feedback to the electric motor 101. The control panel 114 manages the speed and power flow for the generator. The base frame 118 houses the generator.

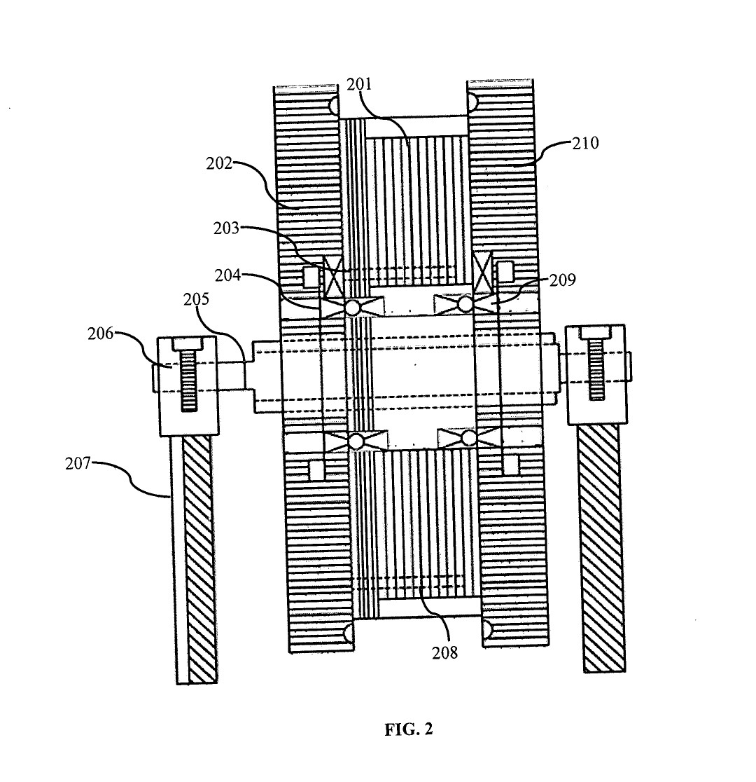

FIG. 2 illustrates a spring assembly in the generator, according to one embodiment herein. With respect to FIG. 2, each stage of spring assembly comprises an internal spring drum 202, a spring coil 201, an outer spring drum 210, an input spring lock 203, a centre shaft 205, an input ball bearing 204, an output ball bearing 209, a bearing housing 206, a stand 207 and an output spring lock 208. The spring assembly comprises an input spring drum 202 with a first gear and an output spring drum 210 with a second gear. The input and output spring drum (202 and 210) rotates in opposite direction with respect to each other. The speed of rotation of both the drums can be same or different as per requirement of amount electrical energy generation. The inner and outer spring drum (202 and 210) houses the spring coil 201 and is connected to a bearing at the internal surface of the spring assembly. The input ball bearing 204 is connected with the input spring drum 202 and the output ball bearing 209 is connected with the output spring drum 210. The central shaft 205 assists in rotation of the input and output spring drums (202 and 210). The bearing housing 206 houses central shaft 105, the input and output spring drums (202 and 210). The stand 207 supports the spring assembly. The inner and outer spring locks (203 and 208) provide locking facility to the input and output spring drums (202 and 210).

According to one embodiment of the present invention, the generator with electrical capability of 125 kva has dimensions of spring drum assembly with size of 670 mm in diameter and 225 mm in width. The drum with a spur gear has a size of 670 mm in diameter and 20 mm in thickness. A gear fixing plate has a size of 610 mm in diameter and 20 mm in thickness. The spring drum has a size of 570 mm in diameter and 100 mm in width and 6 mm in thickness. The input spring drum has a size of 555 mm in diameter, 350 mm in thickness and 80mm in width. The beating housing has a size of 250 mm in diameter, 230 mm in thickness, 230 mm in width and 330 mm in length. The spring coil has a size of 70 mm in width, 2.6 mm in thickness and 19 m in length. The central shaft has a size of 89.8 mm in diameter and 460 mm in length.

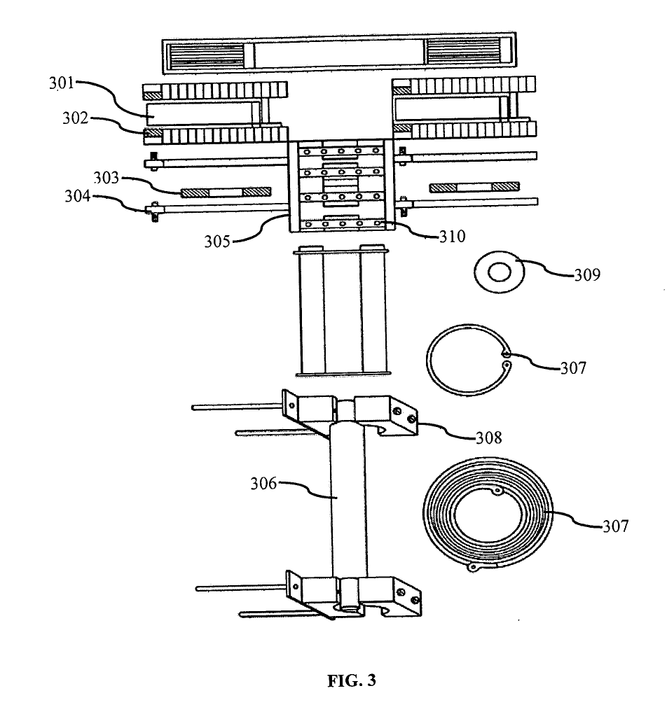

FIG. 3 illustrates a de-assembled view of the spring drum assembly, according to one embodiment herein. With respect to FIG. 3, the spring drum assembly comprises a spring coil 301, an input drum with gear 302, a spacer 303, a bearing cover 309, a plurality of bearings 310, a drum gear lock flange 304, a bearing housing 304, a circular clip 307, a shaft collar 308 and a drum shaft 306. The spring coil 301 is rotated at a particular speed through the drum shaft 306 and the speed control is done by the drum gear 302. The spacer 303 is a metallic and circular strip to maintain a predetermined gap between the bearings 310 during rotation of the spring coil 301. The hearing cover 309 houses the individual bearings 310. The drum gear lock flange 304 provides a rigid support to the drum gear 302 during the rotation of the spring coil 301 to avoid unwanted vibrations. The circular clip 307 holds the bearing and spacer at their places during the rotation of the spring coil 301. The shaft collar 308 provides integral support to the drum shaft 306 at each stage. The bearing housing 304 houses the bearings 310 and drum shaft 306.

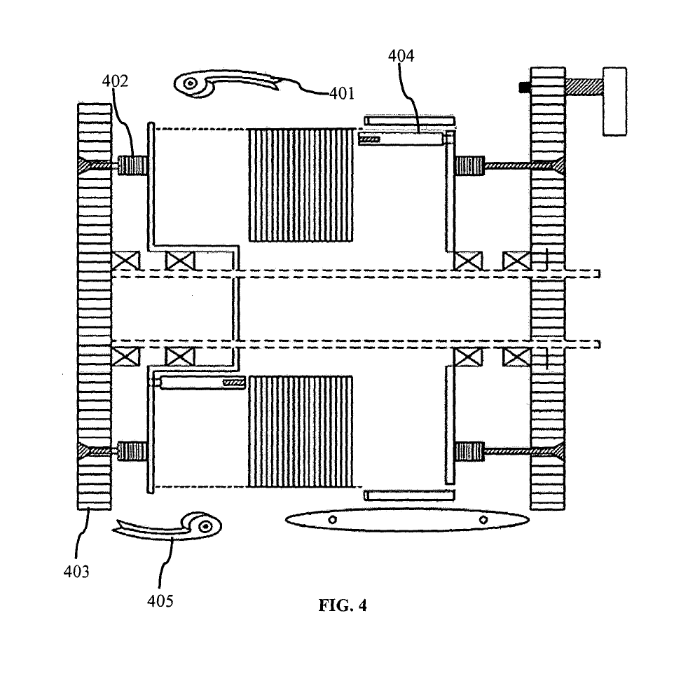

FIG. 4 illustrates an enlarged view of a spring drum assembly, according to one embodiment herein. With respect to FIG. 4, the inner and outer spring drum gear (402 and 403) is attached with the input and output lock pin (401 and 405). The output and input spring lock (403 and 405) maintains the rotation of the spring when a compression cycle is completed. The input and output spring lock (401 and 405) slides in such a way, when a compression cycle is completed and during expansion the movement of spring is in opposite direction to the direction of its movement while compression. Thus, the continuity of spring's compression and expansion is maintained resulting in continuous generation of electrical energy. The spring lock pin 404 provide additional support to the spring coil which its vibration.

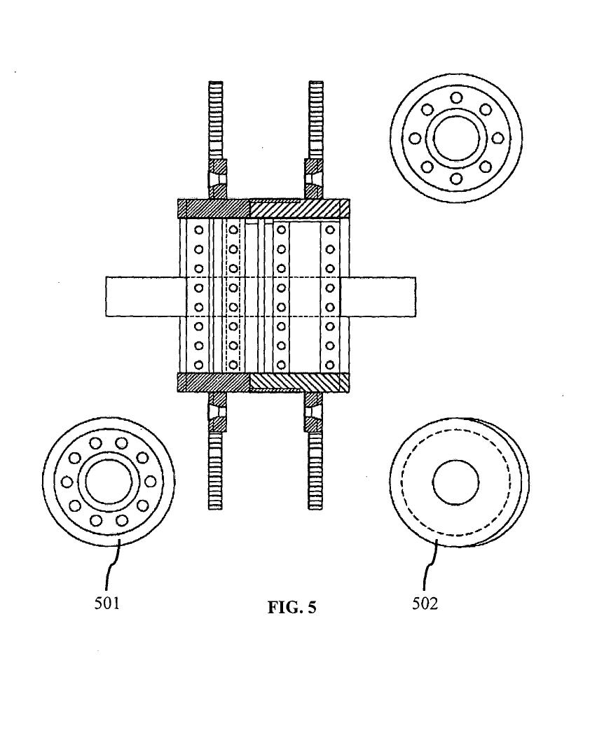

FIG. 5 illustrates an enlarged view of a spring loader cone, according to one embodiment herein. With respect to FIG. 5, the output and input ball bearing (501 and 502) is screwed together and provides the support against vibrations during spring movement.

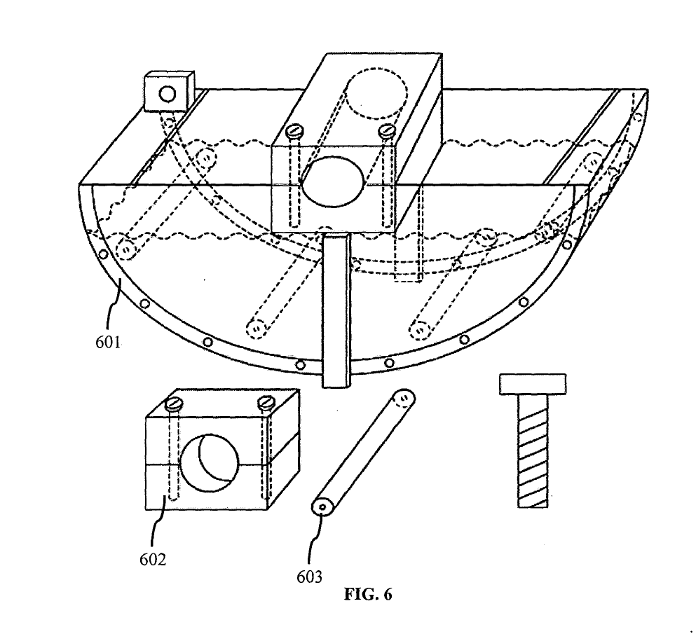

FIG. 6 illustrates a perspective view of spring assembly along with output shell drum, according to one embodiment herein. With respect to FIG. 6, the shell drum comprises two semi-circular plates 601 having thickness of 6 mm. The shaft collar 602 is placed inside the plates and transfers the movement of one stage of spring assembly to follower stage. A plurality of connecting pipe 603 holds the spring drum.

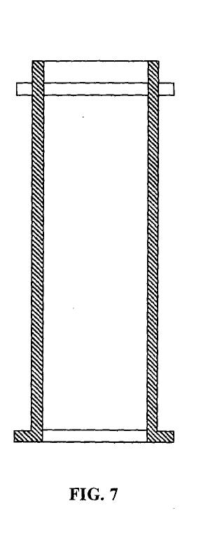

FIG. 7 illustrates a bearing housing in the generator, according to one embodiment herein. With respect to FIG. 7, the bearing housing has an output diameter of 130 mm.

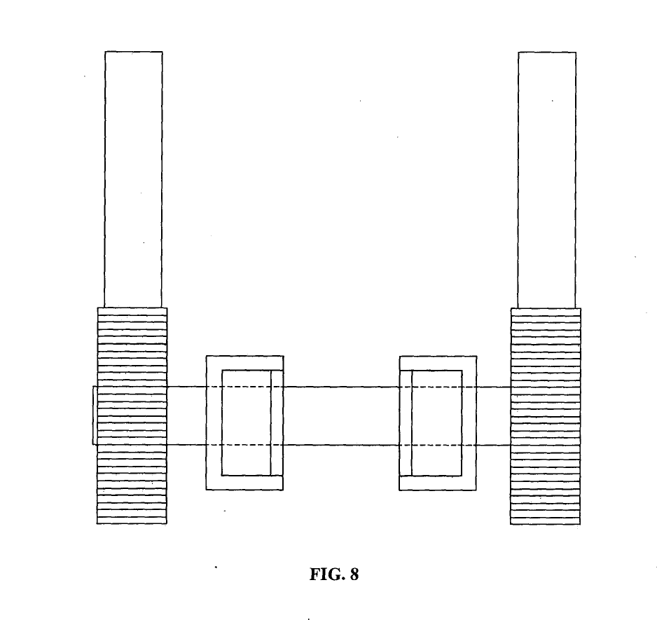

FIG. 8 illustrates a side view of the transmission gear, according to one embodiment herein. With respect to FIG. 8, the transmission s gear is connected with the bearing collar. The bearing collar transfers the rotation of the transmission gear to the bearing housing.

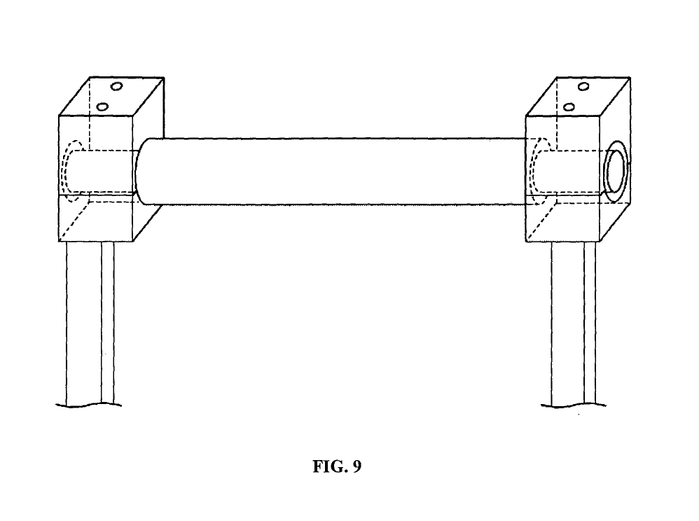

FIG. 9 illustrates a side view of the shaft in the spring assembly, according to one embodiment herein.

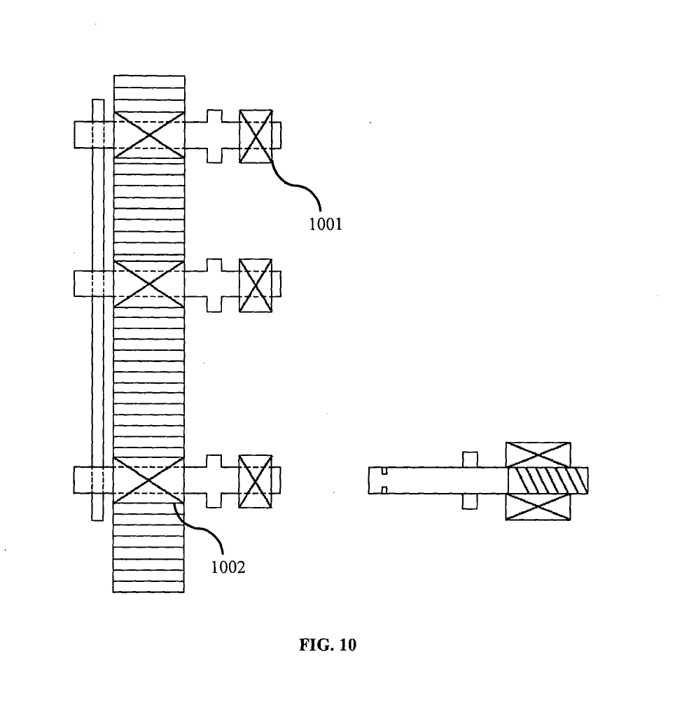

FIG. 10 illustrates a gear assembly in the generator, according to one embodiment herein. With respect to FIG. 10, a gear holding pin 1001 holds the transmission gear at its position during transfer of rotation to each stage of spring assembly. The bearings are prevented from wearing and tearing through gun metal bush 1002.

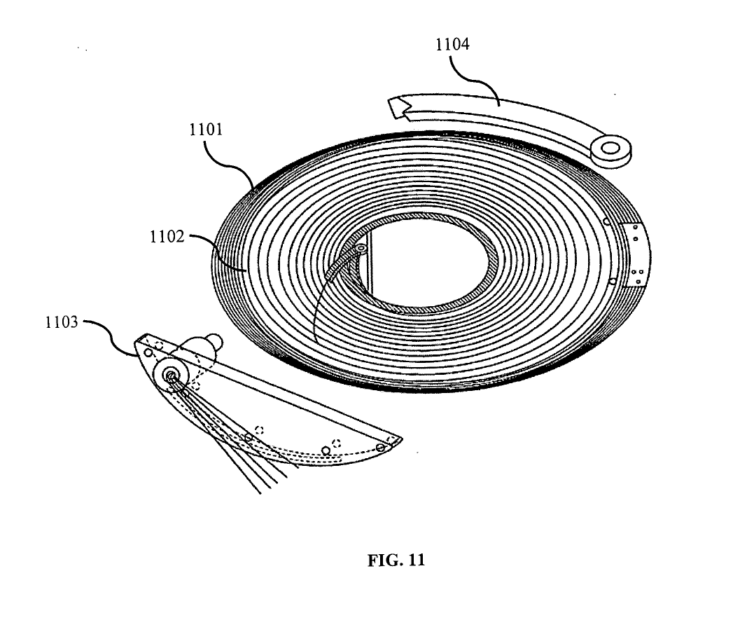

FIG. 11 illustrates a spring guider in the spring assembly, according to one embodiment herein. With respect to FIG. 11, the spring coil 1102 with width of 70 mm, length of 19 m and thickness of 2.6 mm is connected to the output and input lock pin (1103 and 1104) to provide continuous rotation of spring coil 1102. The spring coil 1102 rotates between the spring drum 1101.

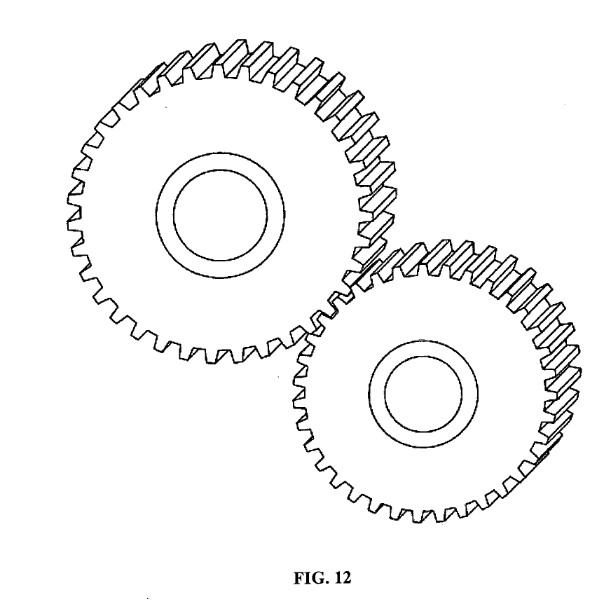

FIG. 12 illustrates a step down and step up gear in the spring assembly, according to one embodiment herein. With respect to FIG. 12, the transmission gear comprises step-up and step-down gear tooth that results in variable rotational speed of the spring coil.

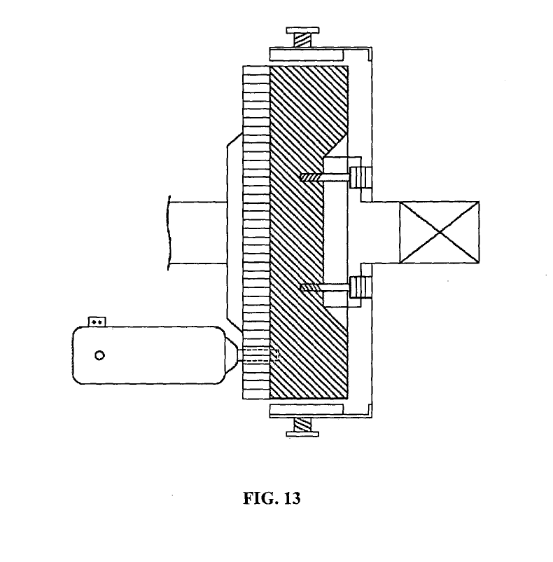

FIG. 13 illustrates flywheel assembly with self-starter and break control, according to one embodiment herein. With respect to FIG. 13, the self-starter is connected to a secondary gear to transfers the generated power to the alternator through the flywheel with dimensions of 450 mm in diameter and 100 mm in width. The flywheel is connected to the alternator through a coupling. The break control facilitates the control of transfer of power from self starter to the alternator.

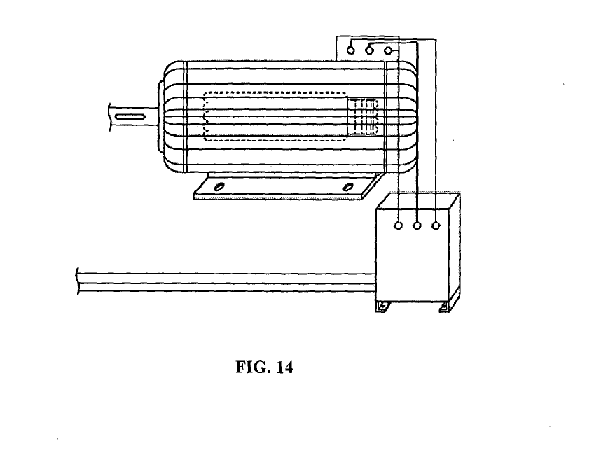

FIG. 14 illustrates an alternator integrated with the control panel, according to one embodiment herein. With respect to FIG. 14, the control panel controls electronically the working speed and on/off status of the generator.

The present invention's generator is portable and does not need any fluid like petrol, diesel, water etc. for its starting or running. The manufacturing and maintenance cost of the generator is highly less due to least complex assembly. The present invention creates minimum noise and provides continuous power generation.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A spring based generator for conversion of a vibrational energy into an electrical energy, the generator comprises:
a self-starter;
a flywheel, wherein the flywheel is connected to the self-starter through an electromechanical means;
an alternator, wherein the alternator is connected to the flywheel through an electromagnetic coupling;
an electrical motor, wherein the electrical motor is connected to the flywheel through a feedback medium, wherein the feedback medium is electrically coupled to the electrical motor;
a spring assembly, wherein the plurality of spring assembly comprises multiple stages of spring energy generation units known as spring drum assembly, wherein the first stage of the spring assembly is connected to electrical motor;
an oil mechanism, wherein the oil mechanism is provided at the bottom of the spring assembly;
a primary transmission gear, wherein the primary transmission gear provides interstage connections for power transmission in the spring assembly;
a secondary transmission gear, wherein the secondary transmission gear connects the spring assembly to a bearing, wherein the bearing is further connected to the alternator;
a power supply, wherein the power supply acts as the feedback to the electric motor;
a control panel, wherein the control panel manages the speed and power flow for the generator;
a base frame, wherein the base frame houses the generator.

2. The generator according to in claim 1, wherein the output power taken from the alternator is in the range of 90-95%.

3. The generator according to in claim 1, wherein the feedback power is taken from the alternator to the electrical motor is in She range 5-10%, wherein the feedback power maintains the continuous flow of power for continuous cranking of spring.

4. The generator according to in claim 1, wherein each stage in the spring assembly comprises:
a shell drum, wherein the shell drum further comprises:
an input spring mechanism, wherein the input spring assembly is connected to the electric motor through a secondary gear;
an output spring mechanism, wherein the outer spring mechanism is connected to the inner spring mechanism at a central axis;
a spring coil, wherein the spring coil is placed between the inner and outer spring mechanism, wherein the spring coil is connected to both the outer and inner spring mechanism;
a central shaft, wherein the centre shaft is fixed in the shell drum with two hearings in the front side and the another two bearings on the rear side, wherein the front side bearing are fixed with cone of the input spring mechanism, wherein the rear side bearing are fixed with output spring drum cone portion, wherein a safety to avoid wear and tear is provided between the bearings, wherein both the inner and outer spring mechanisms are connected with the ends of the spring coil by a clamp.

5. The generator according to in claim 1, wherein the oil assembly comprises:
an oil sump, wherein the oil sump stores lubricating oil for input and output spring assembly and other rotating parts;
an oil pipe, wherein the oil pipe acts as an inlet to fresh oil into the oil sump;
an oil drain, wherein the oil drain acts as an output for used oil from the oil sump;

6. The generator according to claim 1, wherein the inner and outer spring mechanisms moves in opposite direction with same rotational speed.

7. The generator according to claim 1, wherein the inner and outer spring mechanisms moves in opposite direction with different rotational speed.

8. The generator according to claim 1, wherein the spring assembly is assembled and operates in horizontal position to the surface.

9. The generator according to claim 1, wherein the spring assembly is assembled and operates in vertical position to the surface.

10. The generator according to claim 1, wherein the working of generator comprises the steps of:
starting the generator through the self-starter;
transmitting the power from the self starter to the alternator through the alternator through the flywheel, wherein the self-starter initially uses pre-stored battery power to ran the alternator;
providing a 5-10% feedback of the total output electrical energy generated by the alternator to the electrical motor;
supplying the power to the spring assembly through the electromechanical coupling;
compressing and decompressing the spring coil through the opposite directional rotation of the inner and outer spring mechanisms, wherein the inner and outer spring mechanism of each stage moves simultaneously due to the connection with common central shaft;
generating electrical energy due to the compression and decompression of spring, wherein a portion of generated energy is stored in battery through the output taken from the alternator.

11. The generator according to claim 10, wherein the output power taken from the alternator is 120 KVA per hour.
